(19) United States
(12) Patent Application Publication
(10) Pub. No.: US 2015/0183147 A1
(43) Pub. Date: Jul. 2, 2015

(54) METHOD OF FORMING FILMS FOR A COMPONENT

(71) Applicant: HON HAI PRECISION INDUSTRY CO., LTD., New Taipei (TW)

(72) Inventors: FENG-YUEN DAI, Tu-Cheng (TW); JIH-CHEN LIU, New Taipei (TW); HUNG-LIEN YEH, New Taipei (TW); HAN-LUNG LEE, New Taipei (TW); HUNG-CHUN MA, New Taipei (TW); SHUN-CHI TSENG, New Taipei (TW)

(21) Appl. No.: 14/578,895

(22) Filed: Dec. 22, 2014

(30) Foreign Application Priority Data
Dec. 27, 2013 (TW) 102148908

(51) Int. Cl. B29C 45/26; B29C 45/00; B29C 45/14; B29C 71/04

(52) U.S. Cl. CPC B29C 45/26; B29C 71/04; B29C 45/0053; B29C 45/14; B29K 2909/08; B29K 2995/0027; B29K 2105/0097

(57) ABSTRACT

A method of forming films for a component includes providing a curing device. The curing device includes a receiving die defining a groove, a suction device, and a UV curing system. The suction device suctions a component suctioning the component into the groove and defining a gap between the component and the groove. A UV curing glue is injected into the gap, the UV curing glue selected from a monomer, an oligomer, and a photoinitiator. The UV curing glue is cured by the UV curing system so as to form a cured film for easy demolding.

### FIELD

The subject matter herein generally relates to a method of forming films for a component.

### BACKGROUND

A protective film is generally sprayed on a component used in consumer electronics.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure. Implementations of the present technology will now be described, by way of example only, with reference to the attached figure.

FIG. 1 is a flow chart of a method of forming films for a component, according to the present embodiment.

FIG. 2 is a diagrammatic, cross sectional view of the method of forming films for a component of FIG. 1.

FIG. 3 is a diagrammatic, cross sectional view of the method of forming films for a component coupling between a suction device and a receiving die of FIG. 1.

FIG. 4 is a cross sectional view of the method of forming films for a component of FIG. 1 to cure a UV curing glue after injecting the UV curing glue.

FIG. 5 is a cross sectional view of the method of forming films for a component of FIG. 1 to deposit with the cured film after demolding from a groove.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

The present disclosure relates to a method of forming films for a component.

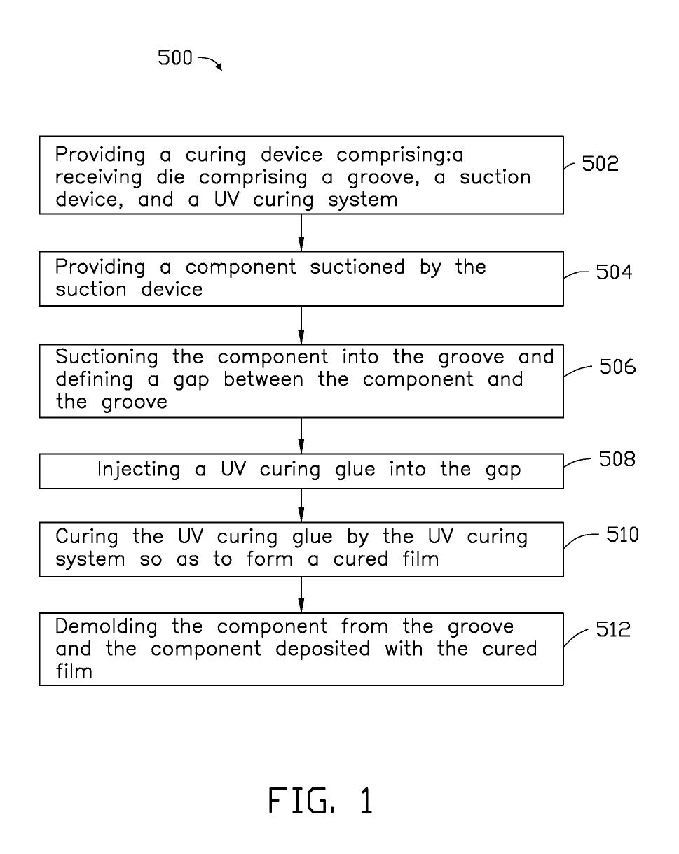

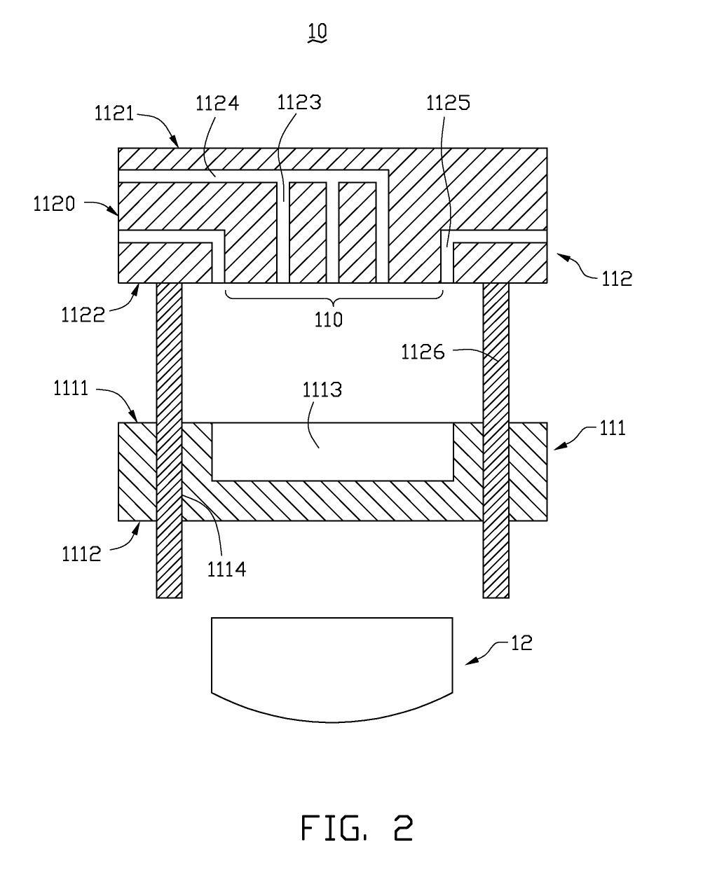

Referring to FIG. 1, a flowchart is presented in accordance with an example embodiment which is being thus illustrated. An example method 500 is provided by way of example, as there are a variety of ways to carry out the method. The method 500 described below can be carried out using the configurations illustrated in FIGS. 2, 3, 4, and 5, for example, and various elements of these figures are referenced in explaining example method 500. Each block shown in FIG. 1 represents one or more processes, methods or subroutines, carried out in the example method 500. Additionally, the illustrated order of blocks is by example only and the order of the blocks can change according to the present disclosure. The example method 500 can begin at block 502.

At block 502, a curing device 10 is provided, the curing device 10 includes a receiving die 111, a suction device 112, and a UV curing system 12, the receiving die 111 includes a groove 1113.

At block 504, A component 20 is provided and the suction device 112 suctions the component 20.

At block 506, the component 20 is suctioned into the groove 1113 and defines a gap 21 between the component 20 and the groove 1113.

At block 508, a UV curing glue 30 is injected into the gap.

At block 510, the UV curing system 12 emits a UV light to the receiving die 111, and passes through the receiving die 111 to cure the UV curing glue 30 so as to form the cured film 40.

At block 512, the component 20 demolds from the groove 1113 and deposits with the cured film 40.

The cross sectional view of the curing device 10 is shown in FIG. 2. The receiving die 111 is formed by transparent materials including plastic and glass that can be transmitted by UV light. The receiving die 111 includes a first surface 1111, a second surface 1112 opposite to the first surface 1111, and a plurality of locating holes 1114 throughout the receiving die 111 from the first surface 1111 to the second surface 1112. The groove 1113 is defined in the first surface 1111. In other embodiments, a plurality of grooves 1113 can be defined in the first surface 1111 and can correspond to a plurality of components 20. The shape of the groove 1113 is similar to the component 20 and the size of the groove 1113 is larger than the component 20. In the embodiment, the shape of the groove 1113 and the component 20 are both cuboid. The surfaces of the component 20 that correspond to the surfaces of the groove 1113 can be deposited with the cured film 40. The surfaces of the groove 1113 includes a demolding layer formed by coating or spray painting and configured to demold the component 20 from the groove 1113 easily and the component 20 is deposited with the cured film 40. The shape of the groove 1113 and the component 20 are not limited to cuboid. The demolding layer of the surfaces of the groove 1113 can not be deposed. The adhesive force between the UV curing glue 30 and the component 20 is stronger than the adhesive force between the UV curing glue 30 and the receiving die 111.

The suction device 112 includes a top surface 1121, a bottom surface 1122 opposite to the top surface 1121, a side surface 1120 interconnected between the top surface 1121 and the bottom surface 1122, a plurality of suction holes 1123, a suction channel 1124 connected to the suction holes 1123, an injecting channel 1125 configured to inject the UV curing glue 30, and a plurality of locating columns 1126 positioned on the bottom surface 1122 and corresponding to the locating holes 1114. The bottom surface 1122 defines an area 110, which the shape of the area 110 is corresponding to the component 20. The suction holes 1123 are defined in the area 110 of the bottom surface 1122 and through into the suction device 112. The suction channel 1124 connects to the side surface 1120 and is configured to draw air from the suction holes 1123. The injecting channel 1125 passes through the suction device 112 from the bottom surface 1122 to the side surface 1120 and behind the area 110. The suction channel 1124 and the injecting channel 1125 are defined through the top surface 1121 instead of the side surface 1120. In other embodiments, a plurality of the areas 110 can correspond to a plurality of the grooves 1113.

The UV curing system 12 is used to emit a UV light and is configured to cure the UV curing glue 30.

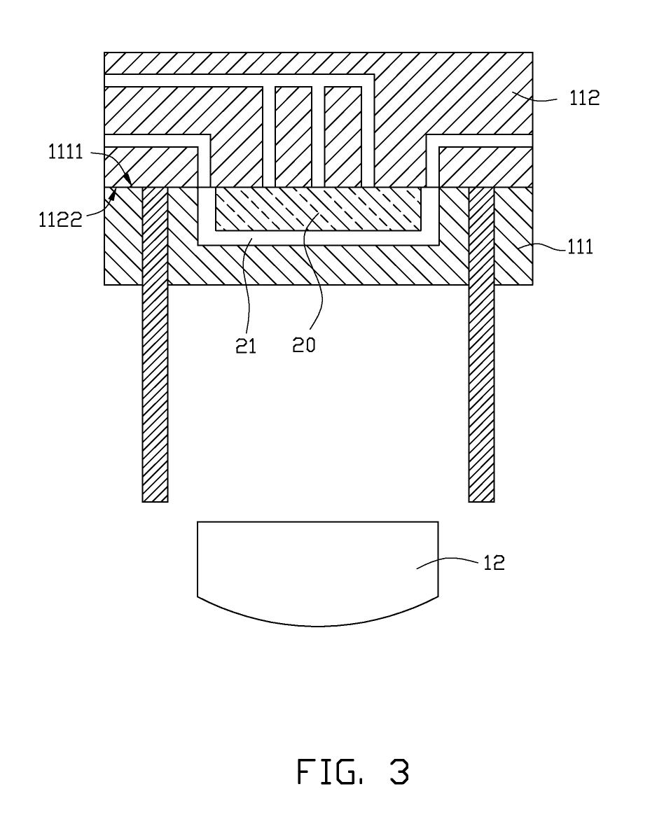

The component 20 coupling between the suction device 112 and the receiving die 111 is shown in FIG. 3. When the suction device 112 suctions the component 20 to the area 110, the suction channel 1124 draws air from the suction holes 1123, and the component 20 correctly aligns with the area 110. The locating columns 1126 are inserted into the locating holes 1114 and the receiving die 111 connects to the suction device 112. The component 20 is suctioned into the groove 1113 and defines a gap 21 between the component 20 and the groove 1113 when the bottom surface 1122 correctly aligns with the first surface 1111 of the receiving die 111. The injecting channel 1125 corresponds to the gap 21, and the width of the gap 21 is the same as the thickness of the cured film 40. In other embodiments, the receiving die 111 connects to the suction device 112 by a connecting device including a snap and a fixture without the locating columns 1126 and the locating holes 1114.

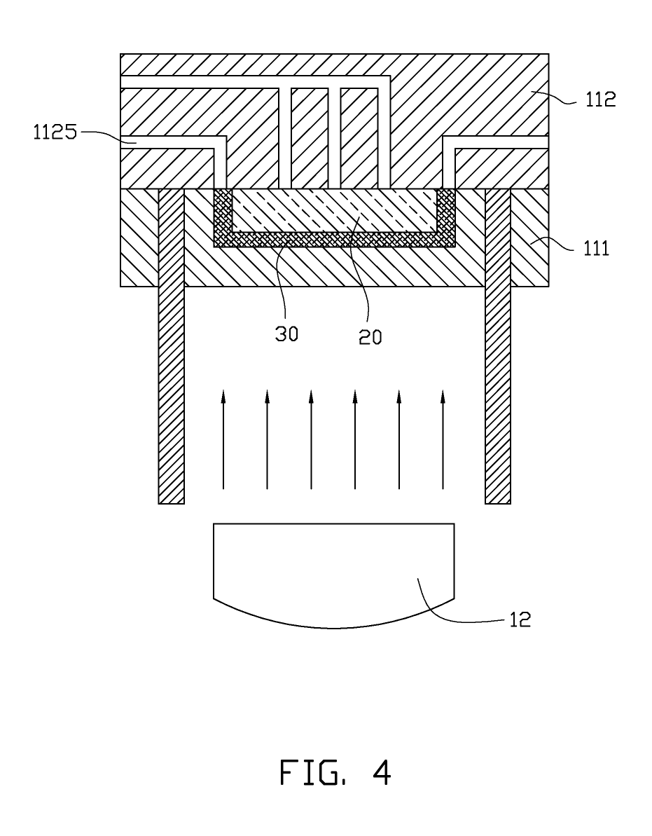

The UV curing system 12 cure a UV curing glue after injecting the UV curing glue is shown in FIG. 4. The UV curing glue 30 is injected into the gap 21 through the injecting channel 1125 and is uniformly filled in the gap 21. The UV curing glue 30 can be selected from a monomer, an oligomer, and a photoinitiator, and the adhesive force between the UV curing glue 30 and the component 20 is stronger than the adhesive force between the UV curing glue 30 and the receiving die 111. The UV curing system 12 emits a UV light to the receiving die 111, and passes through the receiving die 111 to cure the UV curing glue 30 so as to form the cured film 40. In other embodiments, the suction device 112 includes a dispensing device to inject the UV curing glue 30 without the injecting channel 1125, and the size of the bottom surface 1122 of the suction device 112 is smaller than the size of the groove 1113.

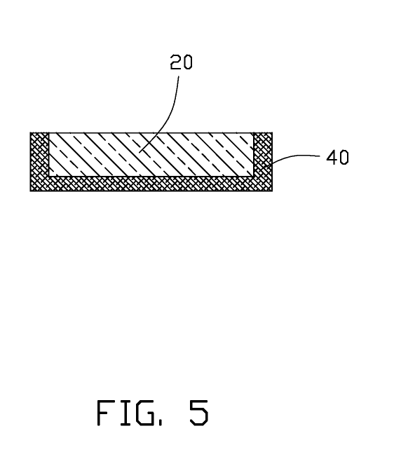

The component 20 deposits with the cured film 40 is shown in FIG. 5. The component 20 is demolded from the groove 1113, and the cured film 40 is deposited on the surfaces of the component 20.

The embodiments shown and described above are only examples. Many details are often found in the art such as the other features of a method of forming films for a component. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method of forming films for a component comprising:
providing a curing device, the curing device comprising:
a receiving die comprising a groove, wherein the receiving die is formed by a transparent material;
a suction device; and
a UV curing system;
providing a component suctioned by the suction device;
suctioning the component into the groove and defining a gap between the component and the groove;
injecting a UV curing glue into the gap, the UV curing glue selected from the group consisting of a monomer, an oligomer, and a photoinitiator, wherein the adhesive force between the UV curing glue and the component is more powerful than the adhesive force between the UV curing glue and the receiving die; and
curing the UV curing glue by the UV curing system so as to form a cured film; and
demolding the component from the groove and the component deposited with the cured film.

2. The method of forming films for a component in accordance with claim 1, wherein the width of the gap is the same with the thickness of the cured film.

3. The method of forming films for a component in accordance with claim 1, wherein the groove includes a demolding layer formed by coating or spray painting.

4. The method of forming films for a component in accordance with claim 1, wherein the suction device includes a top surface, and a bottom surface opposite to the top surface, the bottom surface has an area corresponding to the groove, the shape of the area of the bottom surface corresponds to the component.

5. The method of forming films for a component in accordance with claim 4, wherein the suction device includes a plurality of suction holes, and a suction channel connected to the suction holes, the suction holes is defined in the area of the bottom surface and through into the suction device, the suction channel is configured to draw air from the suction holes.

6. The method of forming films for a component in accordance with claim 4, wherein the suction device includes an injecting channel configured to inject the UV curing glue between the component and the groove, the injecting channel passes through the suction device from the bottom surface to a side surface and behind the area.

7. The method of forming films for a component in accordance with claim 4, wherein the receiving die includes a first surface, a second surface opposite to the first surface, and a plurality of locating holes, the groove of the receiving die is defined in the first surface, the locating holes throughout the receiving die from the first surface to the second surface, the suction device includes a plurality of locating columns position on the bottom surface and corresponds to the locating holes, the locating columns is inserted into the locating holes and the bottom of the suction device aligns with the first surface of the receiving die.

8. The method of forming films for a component in accordance with claim 1, wherein the transparent material includes plastics and glasses.
